(19) United States
(12) Patent Application Publication
(10) Pub. No.: US 2026/0162958 A1
(43) Pub. Date: Jun. 11, 2026

(54) METHOD FOR PREPARING FREE-STANDING ELECTRODE MEMBRANE AND FREE-STANDING ELECTRODE MEMBRANE PREPARED THEREBY

(71) Applicants: Hyundai Motor Company, Seoul (KR); Kia Corporation, Seoul (KR)

(72) Inventors: Ju Young Jang, Hwaseong-si (KR); Ik Hyeon Choi, Hwaseong-si (KR); Byung Yong Lee, Hwaseong-si (KR); Hyo Min Yoo, Hwaseong-si (KR)

(21) Appl. No.: 19/188,962

(22) Filed: Apr. 24, 2025

(30) Foreign Application Priority Data
Dec. 9, 2024 (KR) 10-2024-0181916

(51) Int. Cl. H01M 4/04; H01M 4/02; H01M 4/62; H01M 10/0525; H01M 10/0562

(52) U.S. Cl. CPC H01M 4/0435; H01M 2004/021; H01M 4/623; H01M 10/0525; H01M 10/0562; H01M 2300/0068

(57) ABSTRACT

In an embodiment a method for preparing a free-standing electrode membrane includes preparing a composition for forming an electrode, the composition including an electrode active material, a conductive material, a solid electrolyte, and a binder, first mixing the composition in a first mixer to form a first mixture, pressing the first mixture to form a membrane-shaped aggregate, second mixing the aggregate in a second mixer to form a second mixture and pressing the second mixture to prepare the free-standing electrode membrane.

### CROSS-REFERENCE TO RELATED APPLICATIONS

This application claims priority to Korean Application No. 10-2024-0181916, filed on Dec. 9, 2024, which application is hereby incorporated herein by reference.

### TECHNICAL FIELD

The present disclosure relates to a method for preparing a free-standing electrode membrane comprising a first mixing step using a pulverizing mixer and a second mixing step using a shearing mixer to prepare the free-standing electrode membrane having excellent tensile strength which can be applied to a roll-to-roll process, and having high energy density, and to a free-standing electrode membrane prepared thereby.

### BACKGROUND

An electrode used in a lithium secondary battery is generally prepared by applying and drying an electrode slurry in which components such as an electrode active material, a conductive material, and a binder are dispersed in a solvent to a current collector. As described above, a wet preparing method using a solvent has an advantage in that the electrode layer can be formed more uniformly, but there is a problem in that electrode deterioration may occur due to the solvent as used, and some remaining solvent components that are not completely removed in the subsequent drying process may cause a side reaction. Accordingly, in recent years, a method of preparing an electrode in a dry manner without a solvent has been actively studied.

In the case of a dry preparing method of an electrode, an electrode active material and a conductive material are mixed with a fiberizable binder without a solvent, and then shear stress is applied to the mixture to induce the fiberization of the binder, and the resultant is formed in a sheet form to prepare an electrode layer. In particular, the fiberizable binder initially has a particle shape, but is fiberized while receiving the shear stress during the preparing process of the electrode, and thus has a property of being elongated. However, in the case of such a dry preparing method of an electrode, there is a limit to increasing a thickness of the electrode layer above a certain reference. When the thickness of the electrode layer is large, it does not receive sufficient shear stress in the membrane forming step due to the thickness, which in other words leads to a result that the binder is not sufficiently fiberized. When the binder is not sufficiently fiberized, the tensile force of the electrode layer itself decreases, and thus it is difficult to apply the same to the roll-to-roll process. Therefore, there is a need for research on a new preparing method capable of sufficiently increasing the thickness of the electrode layer while preparing the electrode in a dry manner.

### SUMMARY

Embodiments of the present disclosure have been made to solve the above-mentioned problems occurring in the prior art while advantages achieved by the prior art are maintained intact.

Embodiments of the present disclosure provide a method for preparing a free-standing electrode membrane capable of solving the above problems and a free-standing electrode membrane prepared via the preparing method.

More specifically, embodiments of the present disclosure provide a method for preparing a free-standing electrode membrane which comprises a first mixing step using a pulverizing mixer and a second mixing step using a shearing mixer, thereby first inducing uniform dispersion of binder particles, and then allowing the binder to be sufficiently fiberized using the shearing mixer, such that the free-standing electrode membrane having excellent tensile force and high density of electrode active materials in the free-standing membrane may be realized, and provides a free-standing electrode membrane prepared thereby.

The technical problems to be solved by embodiments of the present disclosure are not limited to the aforementioned problems, and any other technical problems not mentioned herein will be clearly understood from the following description by those skilled in the art to which the present disclosure pertains.

In order to solve the above problems, embodiments of the present disclosure provide a method for preparing a free-standing electrode membrane, a method for preparing an electrode, a free-standing electrode membrane, an electrode, and a lithium secondary battery.

More specifically, (1) the embodiments of present disclosure provide a method for preparing a free-standing electrode membrane, the method comprising: preparing a composition for forming an electrode, the composition including an electrode active material, a conductive material, a solid electrolyte, and a binder; first mixing the composition for forming the electrode in a pulverizing mixer to form a first mixture; pressing the first mixture to form a membrane-shaped aggregate; second mixing the aggregate in a shearing mixer to form a second mixture; and pressing the second mixture to prepare the free-standing electrode membrane.
2) Embodiments of the present disclosure provide the method for preparing the free-standing electrode membrane of the (1), wherein the binder is a fiberizable binder.
3) Embodiments of the present disclosure provide the method for preparing the free-standing electrode membrane of one of the (1) and (2), wherein the binder is at least one selected from a group consisting of polytetrafluoroethylene (PTFE), polyvinylidene fluoride, and a copolymer thereof.
4) Embodiments of the present disclosure provide the method for preparing the free-standing electrode membrane of one of the (1) to (3), wherein the binder is contained in a content of 0.1 parts by weight or greater and 7 parts by weight or smaller based on 100 parts by weight of the electrode active material.
5) Embodiments of the present disclosure provide the method for preparing the free-standing electrode membrane of one of the (1) to (4), wherein the solid electrolyte is contained in a content of 10 parts by weight or greater and 40 parts by weight or smaller based on 100 parts by weight of the electrode active material.
6) Embodiments of the present disclosure provide the method for preparing the free-standing electrode membrane of one of the (1) to (5), wherein the first mixing is performed at a speed of 2,000 rpm or higher and 15,000 rpm or lower and for a time of 0.5 minutes or larger and 60 minutes or smaller.
7) Embodiments of the present disclosure provide the method for preparing the free-standing electrode membrane of one of the (1) to (6), wherein the second mixing is performed at a speed of 100 rpm or higher and 10,000 rpm or lower and for a time of 0.5 minutes or larger and 60 minutes or smaller.
8) Embodiments of the present disclosure provide the method for preparing the free-standing electrode membrane of one of the (1) to (7), wherein the pressing is performed using a roll press or a flat plate press.
9) Embodiments of the present disclosure provide the method for preparing the free-standing electrode membrane of one of the (1) to (8), wherein the pressing is performed under a temperature condition of 10° C. or higher and 120° C. or lower.
10) Embodiments of the present disclosure provide the method for preparing the free-standing electrode membrane of one of the (1) to (11), wherein the second mixture includes spherical particles.
(11) Embodiments of the present disclosure provide a method for preparing an electrode, the method comprising: preparing a composition for forming an electrode, the composition including an electrode active material, a conductive material, a solid electrolyte, and a binder; first mixing the composition for forming the electrode in a pulverizing mixer to form a first mixture; pressing the first mixture to form a membrane-shaped aggregate; second mixing the aggregate in a shearing mixer to form a second mixture; pressing the second mixture to prepare a free-standing electrode membrane; and attaching the free-standing electrode membrane to a current collector.
(12) Embodiments of the present disclosure provide a free-standing electrode membrane comprising an electrode active material, a conductive material, a solid electrolyte, and a fiberized binder, wherein the free-standing electrode membrane has a tensile force of 5 N or greater.
(13) Embodiments of the present disclosure provide the free-standing electrode membrane of the (12), wherein the free-standing electrode membrane has a thickness in a range of 80 to 200 μm.
(14) Embodiments of the present disclosure provide the free-standing electrode membrane of one of the (12) and (13), wherein the free-standing electrode membrane has a tensile strength of 0.15 MPa or greater.
(15) Embodiments of the present disclosure provide the free-standing electrode membrane of one of the (12) to (14), wherein the free-standing electrode membrane has a composite density of 3.5 g/cc or higher and 4.0 g/cc or lower.
(16) Embodiments of the present disclosure provide an electrode for a lithium secondary battery comprising: the free-standing electrode membrane of one of the (12) to (15); and a current collector.
(17) Embodiments of the present disclosure provide a lithium secondary battery comprising the electrode of the (16).

### BRIEF DESCRIPTION OF THE DRAWINGS

The above and other objects, features and advantages of the present disclosure will be more apparent from the following detailed description taken in conjunction with the accompanying drawings:

FIG. 1 is an image showing a free-standing electrode membrane according to Example 1 as observed with an electron scanning microscope (SEM);

FIG. 2 is an image showing a free-standing electrode membrane according to Comparative Example 1 as observed with an electron scanning microscope (SEM);

FIG. 3 is an image showing a free-standing electrode membrane according to Comparative Example 2 as observed with an electron scanning microscope (SEM); and

FIG. 4 is an image showing a free-standing electrode membrane according to Comparative Example 3 as observed with an electron scanning microscope (SEM).

### DETAILED DESCRIPTION OF ILLUSTRATIVE EMBODIMENTS

Terms or words used in this specification and claims should not be interpreted as limited to their usual or dictionary meanings, and should be interpreted as meanings and concepts that comply with the technical ideas of the present disclosure based on the principle that the inventor may appropriately define the concept of the term in order to explain his or her own invention in the best way.

### Method for Preparing Free-Standing Electrode Membrane

The present disclosure provides a method for preparing a free-standing electrode membrane, which includes preparing a composition for forming an electrode, the composition including an electrode active material, a conductive material, a solid electrolyte, and a binder in S1; first mixing the composition for forming the electrode in a pulverizing mixer to form a first mixture in S2; pressing the first mixture to form a membrane-shaped aggregate in S3; second mixing the aggregate in a shearing mixer to form a second mixture in S4; and pressing the second mixture to prepare the free-standing electrode membrane in S5.

### Preparation of Composition for Forming Electrode in S1

The method for preparing the free-standing electrode membrane of the present disclosure includes a step S1 of preparing a composition for forming an electrode, the composition including an electrode active material, a conductive material, a solid electrolyte, and a binder.

The electrode active material may be a positive electrode active material or a negative electrode active material. The positive electrode active material may include a carbon material such as activated carbon, graphene, hard carbon, or soft carbon, or a lithium metal oxide-based or sulfide-based active material. The oxide-based active material may be a dark salt layered active material such as LiCoO₂, LiMnO₂, LiNiO₂, LiVO₂, Li₁₊ₓNi_{1/3}Co_{1/3}Mn_{1/3}O₂, a spinel active material such as LiMn₂O₄, Li(Ni_{0.5}Mn_{1.5})O₄, an inverse spinel active material such as LiNiVO₄, LiCoVO₄, an olivine active material such as LiFePO₄, LiMnPO₄, LiCoPO₄, LiNiPO₄, a silicon-containing active material such as Li₂FeSiO₄, Li₂MnSiO₄, a dark salt layer active material in which a portion of a transition metal is substituted with a heterogeneous metal such as LiNi_{0.8}Co(_{0.2-x})AlₓO₂ (0<x<0.2), a spinel active material in which a portion of the transition metal is substituted with a heterogeneous metal such as Li₁₊ₓMn_{2-x-y}M_{y}O₄ (M is at least one of Al, Mg, Co, Fe, Ni, and Zn, 0<x+y<2), or lithium titanate such as Li₄Ti₅O₁₂. The sulfide-based active material may be copper chevrel, iron sulfide, cobalt sulfide, nickel sulfide, or the like.

The negative electrode active material may include a carbon material such as graphite, hard carbon, or soft carbon, or a material such as lithium metal oxide or silicon.

The conductive material may be a material for increasing the electron conductivity of the free-standing electrode membrane and may include carbon black, conductive graphite, ethylene black, graphene, or the like.

The conductive material in the composition for forming the electrode may be contained in a content of 0.1 parts by weight or greater and 1.5 parts by weight or smaller, preferably 0.1 parts by weight or greater, 0.2 parts by weight or greater, or 0.3 parts by weight or greater and 1.5 parts by weight or smaller, 1.3 parts by weight or smaller, 1.2 parts by weight or smaller, 1.0 parts by weight or smaller, or 0.8 parts by weight or smaller based on 100 parts by weight of the electrode active material. When the content of the conductive material is within the above-described range, the electrical conductivity of the free-standing electrode membrane may be excellent, and at the same time, the mechanical properties thereof may be maintained at an excellent level.

The solid electrolyte is a material for increasing the ionic conductivity of the free-standing electrode membrane, and may include a component as known to be used as a solid electrolyte. For example, an oxide-based solid electrolyte or a sulfide-based solid electrolyte may be used as the solid electrolyte.

The oxide-based solid electrolyte may include a perovskite-type oxide, a garnet-type oxide, or an oxide having a NASICON structure. Examples of the perovskite-type oxide may include lithium lanthanum titanate or lithium lanthanum niobate (LiₓLa_{(1-x)/3}NbO₃, where x is 0 to 1). In addition, the garnet-type oxide may include an oxide represented by a formula of Li_{7-3x+y-z}AₓLa_{3-y}B_{y}Zr_{2-z}M_{z}O₁₂, wherein each of x, y, and z is independently 0 to 1, A is a doping element replacing Li as selected from the group consisting of Al, Ga, Ba, Mg, Ca, K, Ce, and Rb, B is a doping element replacing La as selected from the group consisting of Ga, Ba, Mg, Ca, Sr, K, Ce, and Rb, and M is a doping element replacing Zr as selected from the group consisting of Mo, W, Sb, Y, Nb, and Ta. More specifically, the garnet-type oxide may be Li₇La₃Zr₂O₁₂, Li₅La₃Nb₂O₁₂, Li₅La₃Ta₂O₁₂ or Li₆La₂BaTa₂O₁₂. In addition, the oxide of the NASICON structure may include LAGP (Li₁₊ₓAlₓGe₂₋ₓ(PO₄)₃, wherein x is 0 to 1), LATP (Li₁₊ₓAlₓTi₂₋ₓ(PO₄)₃, wherein x is 0 to 1), and LZP (Li₁₊₄ₓZr₂₋ₓ(PO₄)₃, wherein x is 0 to 0.4).

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where each of m and n is a positive electrode number, and Z is one of Ge, Zn, and Ga), Li₂S—GeS₂, Li₂S—SiS₂—Li₃PO₄, Li₂S—SiS₂-LiₓMO_{y} (where each of x and y is a positive electrode number and M is one of P, Si, Ge, B, Al, Ga, and In), Li₁₀GeP₂S₁₂, etc.

The solid electrolyte in the composition for forming the electrode may be contained in a content of 10 parts by weight or greater and 40 parts by weight or smaller, preferably 10 parts by weight or greater, 12 parts by weight or greater, 15 parts by weight or greater, or 17 parts by weight or greater, and 40 parts by weight or smaller, 35 parts by weight or smaller, 30 parts by weight or smaller, or 25 parts by weight or smaller, based on 100 parts by weight of the electrode active material. When the content of the solid electrolyte is within the above-described range, the ion conductivity of the free-standing electrode membrane may be particularly excellent.

The binder is fiberized via a process to be described later so that the components as described above are bound to each other via the binder. The binder may be a fiberizable binder. More specifically, the binder may be one or more selected from the group consisting of polytetrafluoroethylene (PTFE), polyvinylidene fluoride (PVDF), and a copolymer including these.

The binder in the composition for forming the electrode may be contained in a content of 0.1 parts by weight or greater and 7 parts by weight or smaller, and preferably 0.1 parts by weight or greater, 0.3 parts by weight or greater, or 0.5 parts by weight or greater and 7 parts by weight or smaller, 5 parts by weight or smaller, 3 parts by weight or smaller, or 2.5 parts by weight or smaller based on 100 parts by weight of the electrode active material. When the amount of the binder in the free-standing electrode membrane is too small, the free-standing membrane itself may not be well formed. When the amount of the active material is too large, the content of the active material may be relatively reduced, and thus the composite density of the free-standing electrode membrane may be lowered, and accordingly, the energy density of the lithium secondary battery including the free-standing electrode membrane may be lowered.

The composition for forming the electrode may have a solvent content in a range of 5 wt % or smaller, 4 wt % or smaller, 3 wt % or smaller, 2 wt % or smaller, 1 wt % or smaller, 0.5 wt % or smaller, 0.1 wt % or smaller, or 0.01 wt % or smaller. More specifically, the composition for forming the electrode may not include a solvent. The fact that the solvent is not contained therein may mean that the solvent is substantially not contained in the composition for forming the electrode, and may mean that the solvent intentionally contained in the composition for forming the electrode does not exist.

### First Mixing in S2

A step of first mixing the composition for forming the electrode prepared via the previous step may be performed. The first mixing in this step may be performed in a pulverizing mixer.

The pulverizing mixer used in this step may not apply shear stress to the composition for forming the electrode. When shear stress is applied to the binder contained in the composition for forming the electrode, fiberization may occur such that aggregation between the binders may occur, which may interfere with uniform dispersion of the binders. Therefore, in the present disclosure, since the first mixing step is performed in the pulverizing mixer such that no shear stress is applied, the binder particles themselves are uniformly dispersed in the composition for forming the electrode without the shear stress being applied to the binders. More specifically, the pulverizing mixer may include a vessel for containing therein the composition for forming the electrode, and a blade for mixing the same, wherein a narrow gap between the vessel and the blade may not be formed.

In this step, the first mixing may be performed at a speed of 2,000 rpm or higher and 15,000 rpm or lower, preferably 2,000 rpm or higher, 3,000 rpm or higher, 5,000 rpm or higher, 7000 rpm or higher, or 8,000 rpm or higher and 15,000 rpm or lower, 14,000 rpm or lower, 13,000 rpm or lower, 12,000 rpm or lower, 11,000 rpm or lower, or 10,000 rpm or lower. In addition, the first mixing may be performed for a time of 0.5 minutes or larger and 60 minutes or smaller, preferably 0.5 minutes or larger, 1 minute or more, 3 minutes or larger, or 5 minutes or larger and 60 minutes or smaller, 50 minutes or smaller, 40 minutes or smaller, 30 minutes or smaller, 20 minutes or smaller, 15 minutes or smaller, or 10 minutes or smaller. When the speed and time of the first mixing are not appropriate, the binder may not be sufficiently dispersed in the composition for forming the electrode, or a phenomenon in which components in the composition for forming the electrode are damaged during the mixing process may occur.

### First Pressing in S3

The method for preparing the free-standing electrode membrane of the present disclosure may include a step of first pressing the first mixture obtained via the first mixing step to prepare a membrane-shaped aggregate.

Since the first mixture obtained via the first mixing is in a state in which the fiberization of the binder is not achieved, the binding force between the respective components in the mixture is insignificant. Thus, the first mixture is first pressed in this step to induce the fiberization of some of the binders, thereby allowing the respective components in the form of powders to be aggregated with each other. In particular, when the second mixing step is directly performed without the first pressing step, the binder particles dispersed via the first mixing step may be aggregated with each other again. In the first pressing step, the binder particles dispersed via the first mixing step may be maintained in a dispersed state.

The pressurization in this step may be performed using a roll press or a flat plate press, and preferably may be performed using the roll press.

The pressurization in this step may be performed under a temperature condition of 10° C. or higher and 120° C. or lower, and preferably may be performed under a temperature condition of 10° C. or higher, 20° C. or higher, 30° C. or higher, 40° C. or higher, 50° C. or higher, or 60° C. or higher and 120° C. or lower, 110° C. or lower, 100° C. or lower, 90° C. or lower, or 85° C. or lower. When the pressurization temperature in this step is within an appropriate range, it may be easy to form the aggregate.

### Second Mixing in S4

The agglomerate in the form of the membrane formed via the previous step may be subjected to second mixing again to form a second mixture. Like the first mixture, the second mixture may be in a form in which powders of various components are mixed with each other. The second mixing in this step may be performed using a shearing mixer.

Unlike the previous pulverizing mixer, the shearing mixer used in this step may be configured for applying the shear stress to the aggregate during the mixing process. In this step, a large amount of the binders in the aggregate may be fiberized, and thus, the fiberization may be performed in a state in which the binders are uniformly dispersed to form the second mixture including spherical particles. The spherical particle may be obtained by binding the binder, the electrode active material, the conductive material, and the solid electrolyte to each other. More specifically, the shearing mixer includes a vessel for receiving therein the aggregate, and a blade for mixing, wherein a narrow gap is formed between the vessel and the blade so that the aggregate may be converted into the spherical particles while the aggregate passes through the narrow gap in a repeated manner. In particular, in the present disclosure, the pulverizing mixer is used in the first mixing step and the shearing mixer is used in the second mixing step. When the shearing mixer is used first and then the pulverizing mixer is used later, it is not possible to obtain a form in which the binder particles are dispersed. However, the spherical particles can be obtained only by using the pulverizing mixer first and then the shearing mixer in accordance with the present disclosure.

In this step, the second mixing may be performed at a speed of 100 rpm or higher and 10,000 rpm or lower, preferably 100 rpm or higher, 300 rpm or higher, 500 rpm or higher, 1,000 rpm or higher, 1,500 rpm or higher, or 2,000 rpm or higher and 10,000 rpm or lower, 8,000 rpm or lower, 7,000 rpm or lower, 6,000 rpm or lower, 5,000 rpm or lower, or 4,500 rpm or lower. In addition, the second mixing may be performed for a time of 0.5 minutes or larger and 60 minutes or smaller, preferably 0.5 minutes or larger, 1 minute or more, 3 minutes or larger, or 5 minutes or larger and 60 minutes or smaller, 50 minutes or smaller, 40 minutes or smaller, 30 minutes or smaller, 20 minutes or smaller, 15 minutes or smaller, or 10 minutes or smaller. When the speed and time of mixing are appropriate, the fiberization of the binder may be appropriately performed.

### Second Pressing in S5

The second mixture obtained via the previous step may be pressed such that the free-standing electrode membrane may be finally prepared. The pressurization in this step may be applied in the same manner as in the first pressurization step described above.

### Electrode Preparing Method

The present disclosure provides a method for preparing an electrode using the free-standing electrode membrane prepared via the method for preparing the free-standing electrode membrane as described above.

More specifically, the present disclosure provides a method for preparing an electrode comprising preparing a composition for forming an electrode, the composition including an electrode active material, a conductive material, a solid electrolyte, and a binder in S1; first mixing the composition for forming the electrode in a pulverizing mixer to form a first mixture in S2; pressing the first mixture to form a membrane-shaped aggregate in S3; second mixing the aggregate in a shearing mixer to form a second mixture in S4; pressing the second mixture to prepare a free-standing electrode membrane in S5; and attaching the free-standing electrode membrane to a current collector in S6.

The contents as described above in the steps S1 to S5 in the method for preparing the free-standing electrode membrane may be applied to the steps S1 to S5 in the method for preparing the electrode in the same manner.

Step S6 is a step of finally preparing the electrode including the current collector and the free-standing electrode membrane by attaching the prepared free-standing electrode membrane to the current collector. Step S6 may be performed according to a conventional lamination process. The current collector used in this step may vary depending on whether the electrode active material contained in the free-standing electrode membrane is a positive electrode active material or a negative electrode active material. In one example, copper, stainless steel, aluminum, nickel, titanium, palladium, calcined carbon, copper or stainless steel surface-treated with carbon, nickel, silver, or the like, an aluminum-cadmium alloy, or the like may be used as the current collector.

### Free-Standing Electrode Membrane

The present disclosure provides a free-standing electrode membrane prepared via the method for preparing the free-standing electrode membrane as described above.

More specifically, the present disclosure provides a free-standing electrode membrane comprising an electrode active material, a conductive material, a solid electrolyte, and a fiberized binder, wherein the tensile force of the free-standing electrode membrane is 5 N or greater.

The free-standing electrode membrane provided according to the present disclosure may be prepared to have a sufficiently large thickness via a mixing process including two steps, and at the same time, the tensile force may be high as the binder in the free-standing electrode membrane is fiberized in a state of being uniformly dispersed. More specifically, the tensile force may be 5N or greater, 6N or greater, 7N or greater, 8N or greater, or 9N or greater, and 20N or smaller, 15N or smaller, 13N or smaller, 12N or smaller, 11N or smaller, or 10N or smaller. The free-standing electrode membrane of the present disclosure may have the tensile force of 5 N or greater and thus may be applied to a roll-to-roll process.

The tensile force may be calculated based on a multiplication between the tensile strength of the free-standing electrode membrane, the thickness of the free-standing electrode membrane, and the width of the free-standing electrode membrane, and the tensile force may be measured under a condition in which the width of the free-standing electrode membrane is 300 mm.

The free-standing electrode membrane provided according to the present disclosure may have a thickness of 80 to 200 μm, preferably 80 μm or larger, 90 μm or larger, 100 μm or larger, 110 μm or larger, 120 μm or larger, 130 μm or larger, 140 μm or larger, 150 μm or larger, or 152 μm or larger, and may be 200 μm or smaller, 190 μm or smaller, 180 μm or smaller, 170 μm or smaller, 160 μm or smaller, or 158 μm or smaller.

The free-standing electrode membrane provided according to the present disclosure may have a tensile strength of 0.15 MPa or greater, preferably 0.15 MPa or greater and 0.3 MPa or smaller, and more specifically, 0.15 MPa or greater, 0.18 MPa or greater, or 0.2 MPa or greater, and 0.3 MPa or smaller, 0.25 MPa or smaller, 0.23 MPa or smaller, or 0.21 MPa or smaller.

The free-standing electrode membrane provided according to the present disclosure may have a composite density of 3.5 g/cc or higher and 4.0 g/cc or lower, preferably 3.5 g/cc or higher or 3.55 g/cc or higher, and 4.0 g/cc or lower, 3.9 g/cc or lower, 3.8 g/cc or lower, or 3.7 g/cc or lower. The free-standing electrode membrane of the present disclosure may have the above-described composite density to increase the energy density of the lithium secondary battery.

### Electrode for Lithium Secondary Battery and Lithium Secondary Battery

The present disclosure provides an electrode for a lithium secondary battery including the free-standing electrode membrane described above and a lithium secondary battery including the same.

More specifically, the present disclosure provides an electrode for a lithium secondary battery including the above-described free-standing electrode membrane and a current collector.

More specifically, the present disclosure provides a lithium secondary battery including the electrode as described above.

The lithium secondary battery provided according to the present disclosure may be an all-solid-state battery that does not include a liquid electrolyte, and thus may include a positive electrode, a negative electrode, and a solid electrolyte layer.

Hereinafter, the present disclosure will be described in more detail with reference to Examples. However, the following Examples are for illustrating the present disclosure, and the scope of the present disclosure is not limited thereto.

### Example 1

A composition for forming an electrode including an electrode active material, a conductive material, a solid electrolyte, and polytetrafluoroethylene was prepared.

The prepared composition for forming the electrode was put into the pulverizing mixer, and first mixed therein at a speed of 6,000 rpm for 5 minutes to form the first mixture.

The formed first mixture was roll-pressed under a temperature condition of 100° C. to form the membrane-shaped aggregate.

The formed aggregate was again put into the shearing mixer, and second mixed therein at a speed of 3,000 rpm for 5 minutes to form the second mixture.

The second mixture was roll-pressed again under a temperature condition of 100° C. to prepare the free-standing electrode membrane.

### Comparative Example 1

A free-standing electrode membrane was prepared in the same manner as in Example 1, except that second mixing was not performed.

### Comparative Example 2

A free-standing electrode membrane was prepared in the same manner as in Example 1, except that the first mixing was performed in the shearing mixer and the second mixing was not performed.

### Comparative Example 3

A free-standing electrode membrane was prepared in the same manner as in Example 1, except that the second mixing was performed in the pulverizing mixer.

The preparing conditions of Example 1 and Comparative Examples 1 to 3 are summarized in Table 1 as set forth below.

TABLE 1

| | First | First | Second | Second |
|---|---|---|---|---|
| | mixing | pressing | mixing | pressing |
| Example 1 | Pulverizing | ◯ | Shearing | ◯ |
| | mixer | | mixer | |
| Comparative | Pulverizing | X | X | ◯ |
| Example 1 | mixer | | | |
| Comparative | Shearing | X | X | ◯ |
| Example 2 | mixer | | | |
| Comparative | Pulverizing | ◯ | Pulverizing | ◯ |
| Example 3 | mixer | | mixer | |

### Experimental Example 1. Evaluation of Characteristics of Free-Standing Electrode Membrane

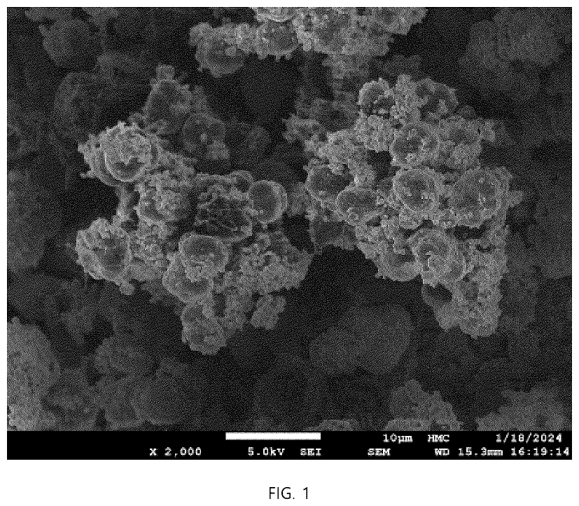

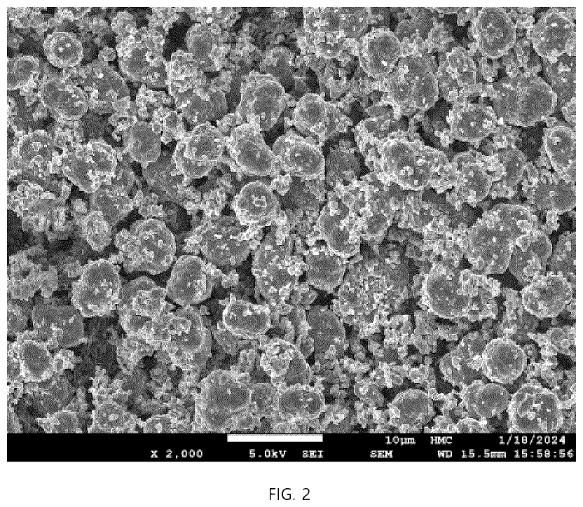

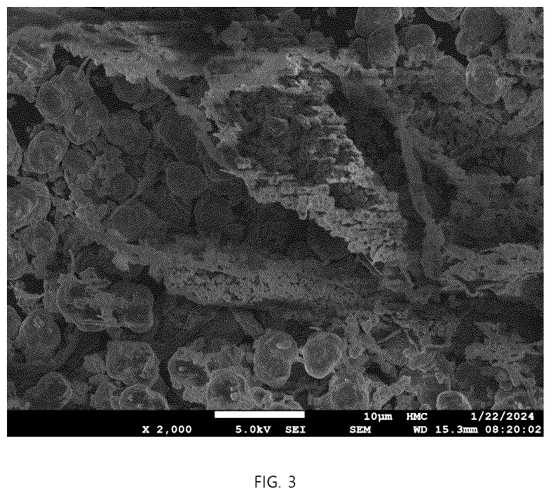

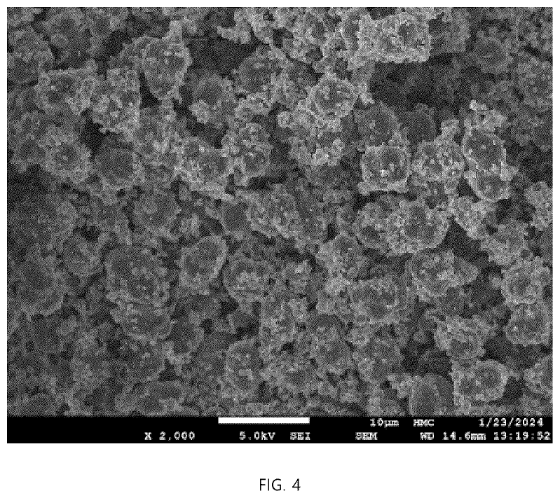

The composite density, thickness, tensile strength, and tensile force of the free-standing electrode membranes as prepared in each of Example 1 and Comparative Examples 1 to 3 were measured/calculated and summarized in the following Table 2. In addition, the surface of the free-standing electrode membrane was observed with a SEM image and shown in FIGS. 1 to 4. Each characteristic was measured or calculated via the following method.
1) Composite density (g/cc): The prepared free-standing electrode membrane was rolled at a pressure of 450 MPa using a hydraulic press, and then the composite density was calculated by dividing a weight of the free-standing electrode membrane by a multiplication between the area and the thickness of the free-standing electrode membrane.

$$Composite density = electrode weight / ( electrode area * electrode thickness )$$

2) Thickness (μm): The thickness of the free-standing electrode membrane was directly measured using a micrometer meter.
3) Tensile strength (MPa): the tensile strength was measured using a tensile strength meter. More specifically, the free-standing electrode membrane was punched to have a size of 2 cm in width and 4 cm in length, and the tensile strength thereof was measured at a scan speed of 20 mm/min.
4) Tensile force (N): It was calculated based on the following equation based on a membrane-forming width 300 mm.

$$Tensile strength = Tensile strength \times Electrode Free - Standing Membrane Thickness \times Membrane - forming width$$

TABLE 2

| | Composite | | Tensile | Tensile |
|---|---|---|---|---|
| | density | Thickness | strength | force |
| Example 1 | 3.6 | 155 | 0.2 | 9.3 |
| Comparative | 3.6 | 150 | 0.1 | 4.5 |
| Example 1 | | | | |
| Comparative | 3.5 | 145 | 0.1 | 4.4 |
| Example 2 | | | | |
| Comparative | 3.3 | 155 | 0.1 | 4.7 |
| Example 3 | | | | |

From the results of Table 2, it was identified that the free-standing electrode membrane of the present disclosure may be formed to have a thickness larger than that of the free-standing electrode membrane of each of Comparative Examples 1 and 2 which had undergone only the first mixing. In addition, in the case of the free-standing electrode membrane of Comparative Example 3 subjected to the second mixing as in Example 1, the thickness of the free-standing electrode membrane was the same as that of Example 1. However, since the shearing mixer was not used in Comparative Example 3, the fiberization did not sufficiently occur, and thus the tensile strength and the composite density thereof were measured to be low, and as a result, the tensile force of the free-standing electrode membrane was also lower than that of Example 1.

In particular, in order to apply the free-standing electrode membrane to the roll-to-roll process, the tensile force thereof should be at least 5 N. In this regard, it was identified that only the free-standing electrode membrane of Example 1 with the tensile force of 5 N or greater may be applied to the roll-to-roll process.

In addition, it was also identified from FIGS. 1 to 4 that the binder was uniformly dispersed in the free-standing electrode membrane of the present disclosure, the fiberization was performed in an excellent manner, and the spherical particles were formed. However, it was identified that in the case of the free-standing electrode membrane of Comparative Example 1 using only the pulverizing mixer, the dispersion of the binder was excellent, but the fiberization was performed insufficiently, and in the case of the free-standing electrode membrane of Comparative Example 2 using only the shearing mixer, the fiberization was excellent, but the binder was not uniformly dispersed. It was also identified that in the case of the free-standing electrode membrane of Comparative Example 3 in which only the pulverizing mixer was used twice, the fiberization was insufficient.

The method for preparing the free-standing electrode membrane of the present disclosure comprises: the first mixing step of minimizing shear stress applied to the binder and allowing the binder particles to be uniformly dispersed as much as possible; and the second mixing step of applying sufficient shear stress to the uniformly dispersed binder particles, thereby enabling the binder to be sufficiently fiberized. Thus, the free-standing electrode membrane can be manufactured in which the binder is uniformly distributed within the free-standing electrode membrane and at the same time the binder is sufficiently fiberized to exhibit high tensile strength.

In addition, the second mixture obtained during the process of preparing the free-standing electrode membrane of the present disclosure includes the spherical aggregate. When the aggregate is spherical, the feeding in the membrane forming process is uniform, so that a more uniform free-standing electrode membrane can be prepared.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for preparing an electrode membrane, the method comprising:
preparing a composition for forming an electrode, the composition including an electrode active material, a conductive material, a solid electrolyte, and a binder;
first mixing the composition in a first mixer to form a first mixture;
pressing the first mixture to form a membrane-shaped aggregate;
second mixing the aggregate in a second mixer to form a second mixture; and
pressing the second mixture to prepare the electrode membrane.

2. The method of claim 1, wherein the binder is a fiberizable binder.

3. The method of claim 1, wherein the binder is selected from the group consisting of polytetrafluoroethylene (PTFE), polyvinylidene fluoride, and a copolymer thereof.

4. The method of claim 1, wherein the binder comprises of 0.1 parts by weight or greater and 7 parts by weight or smaller based on 100 parts by weight of the electrode active material.

5. The method of claim 1, wherein the solid electrolyte is contained in a content of 10 parts by weight or greater and 40 parts by weight or smaller based on 100 parts by weight of the electrode active material.

6. The method of claim 1, wherein first mixing is performed at a speed of 2,000 rpm or higher and 15,000 rpm or lower and for a time of 0.5 minutes or larger and 60 minutes or smaller.

7. The method of claim 1, wherein the second mixing is performed at a speed of 100 rpm or higher and 10,000 rpm or lower and for a time of 0.5 minutes or larger and 60 minutes or smaller.

8. The method of claim 1, wherein pressing the first and second mixtures is performed using a roll press or a flat plate press.

9. The method of claim 1, wherein pressing the first and second mixtures is performed under a temperature condition of 10° C. or higher and 120° C. or lower.

10. The method of claim 1, wherein the second mixture includes spherical particles.

11. The method of claim 1, wherein the first mixer is a pulverizing mixer and the second mixer is a shearing mixer.

12. The method of claim 1, wherein the electrode active material comprises a first carbon based material, an oxide based active material or a sulfide based active material, wherein the conductive materials comprises a second carbon based material, wherein the solid electrolyte material comprises an oxide-based solid electrolyte or a sulfide-based solid electrolyte, and wherein the binder is selected from the group consisting of polytetrafluoroethylene (PTFE), polyvinylidene fluoride, and a copolymer thereof.

13. The method of claim 1, wherein the binder comprises 0.5 parts by weight or greater and 2.5 parts by weight or smaller, wherein the conductive material comprises 0.3 parts by weight or greater and 0.8 parts by weight or smaller, wherein the solid electrolyte comprises 17 parts by weight or greater and 25 parts by weight or smaller, and wherein all weight percentages are based on 100 parts by weight of the electrode active material.

14. A method for preparing an electrode, the method comprising:
preparing a composition for forming the electrode, the composition including an electrode active material, a conductive material, a solid electrolyte, and a binder;
first mixing the composition in a pulverizing mixer to form a first mixture;
pressing the first mixture to form a membrane-shaped aggregate;
second mixing the aggregate in a shearing mixer to form a second mixture;
pressing the second mixture to prepare a free-standing electrode membrane; and
attaching the free-standing electrode membrane to a current collector.

15. An electrode membrane comprising:
an electrode active material;
a conductive material; and
a solid electrolyte; and
a fiberized binder,
wherein the electrode membrane has a tensile force of 5 N or greater.

16. The electrode membrane of claim 15, wherein the electrode membrane has a thickness in a range of 80 μm to 200 μm.

17. The electrode membrane of claim 15, wherein the electrode membrane has a tensile strength of 0.15 MPa or greater.

18. The electrode membrane of claim 15, wherein the electrode membrane has a composite density of 3.5 g/cc or higher and 4.0 g/cc or lower.

19. An electrode for a lithium secondary battery comprising:
the electrode membrane of claim 15; and
a current collector.

20. A lithium secondary battery comprising:
the electrode of claim 19.
